(19) United States
(12) Patent Application Publication
(10) Pub. No.: US 2026/0362269 A1
(43) Pub. Date: Nov. 12, 2026

(54) MULTIPLE TARGET AP MLD PREPARATION PROCEDURE FOR SEAMLESS ROAMING

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/646,021

(22) Filed: Apr. 13, 2026

Related U.S. Application Data
(60) Provisional application No. 63/802,386, filed on May 8, 2025.
(60) Provisional application No. 63/848,713, filed on Jul. 22, 2025.
(60) Provisional application No. 63/915,830, filed on Nov. 12, 2025.
(60) Provisional application No. 63/970,011, filed on Jan. 28, 2026.

(51) Int. Cl. H04W 36/08; H04W 36/18; H04W 88/06

(52) U.S. Cl. CPC H04W 36/08; H04W 36/18; H04W 88/06

(57) ABSTRACT

Methods and apparatuses for supporting a multiple target access point (AP) multi-link device (MLD) preparation procedure for seamless roaming. A method performed by a non-access point (AP) multi-link device (MLD) includes receiving, from a current AP MLD via a seamless mobility domain (SMD) Information element, information indicating a maximum number of target AP MLDs that the non-AP MLD can have in a prepared state during a SMD basic service set (BSS) transition procedure for the non-AP MLD to transition from the current AP MLD to a first target AP MLD. The method includes transmitting, to the current AP MLD, a first preparation request for preparation of the first target AP MLD. The method further includes receiving, from the current AP MLD, a first preparation response including information indicating successful or unsuccessful preparation of the first target AP MLD.

### CROSS-REFERENCE TO RELATED APPLICATION(S) AND CLAIM OF PRIORITY

This application claims priority under 35 U.S.C. § 119 (e) to U.S. Provisional Patent Application No. 63/802,386, filed on May 8, 2025, U.S. Provisional Patent Application No. 63/848,713, filed on Jul. 22, 2025, U.S. Provisional Patent Application No. 63/915,830, filed on Nov. 12, 2025, and U.S. Provisional Patent Application No. 63/970,011, filed on Jan. 28, 2026. The above identified provisional patent applications are hereby incorporated by reference in their entirety.

### TECHNICAL FIELD

This disclosure relates generally to wireless communication, and more specifically to multiple target access point (AP) multi-link device (MLD) preparation procedure for seamless roaming.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for multiple target AP MLD preparation procedure for seamless roaming.

In one embodiment, a method performed by a non-access point (AP) multi-link device (MLD) includes receiving, from a current AP MLD via a seamless mobility domain (SMD) Information element, information indicating a maximum number of target AP MLDs that the non-AP MLD can have in a prepared state during a SMD basic service set (BSS) transition procedure for the non-AP MLD to transition from the current AP MLD to a first target AP MLD. The method includes transmitting, to the current AP MLD, a first preparation request for preparation of the first target AP MLD. The method includes receiving, from the current AP MLD, a first preparation response including information indicating successful or unsuccessful preparation of the first target AP MLD.

In another embodiment, a method performed by an AP MLD includes transmitting, to a non-AP MLD via a SMD Information element, information indicating a maximum number of target AP MLDs that the non-AP MLD can have in a prepared state during a SMD BSS transition procedure for the non-AP MLD to transition from the current AP MLD to a first target AP MLD. The method includes receiving, from the non-AP MLD, a first preparation request for preparation of the first target AP MLD. The method includes transmitting, to the non-AP MLD, a first preparation response including information indicating successful or unsuccessful preparation of the first target AP MLD.

In yet another embodiment, a non-AP MLD comprises at least one processor including processing circuitry, and memory storing instructions. The instructions, when executed by the at least one processor individually or collectively, cause the non-AP MLD to receive, from a current AP MLD via a SMD Information element, information indicating a maximum number of target AP MLDs that the non-AP MLD can have in a prepared state during a SMD BSS transition procedure for the non-AP MLD to transition from the current AP MLD to a first target AP MLD. The instructions, when executed by the at least one processor individually or collectively, cause the non-AP MLD to transmit, to the current AP MLD, a first preparation request for preparation of the first target AP MLD. The instructions, when executed by the at least one processor individually or collectively, cause the non-AP MLD to receive, from the current AP MLD, a first preparation response including information indicating successful or unsuccessful preparation of the first target AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example seamless mobility domain (SMD) information element format according to embodiments of the present disclosure;

FIG. 4 illustrates another example SMD information element format according to embodiments of the present disclosure;

FIG. 5 illustrates an example status code field according to embodiments of the present disclosure;

FIG. 6 illustrates an example flow diagram of multiple target AP MLD preparation according to embodiments of the present disclosure; and

FIG. 7 illustrates an example method performed by a non-access point (AP) multi-link device (MLD) in a wireless communication system according to embodiments of the present disclosure.

### DETAILED DESCRIPTION

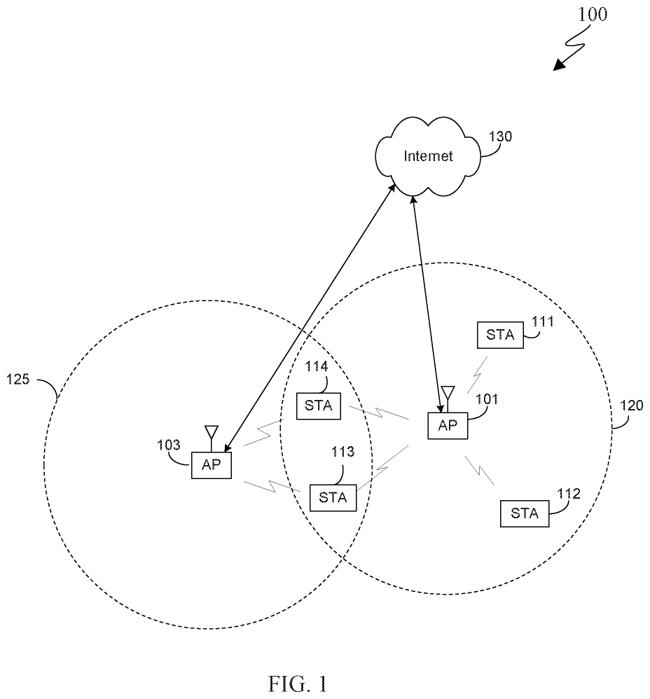

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D7.0, 2024; [2] IEEE Std. 802.11-2020; [3] IEEE P802.11bn/D0.1, 2025.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for supporting a multiple target AP MLD preparation procedure for seamless roaming. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

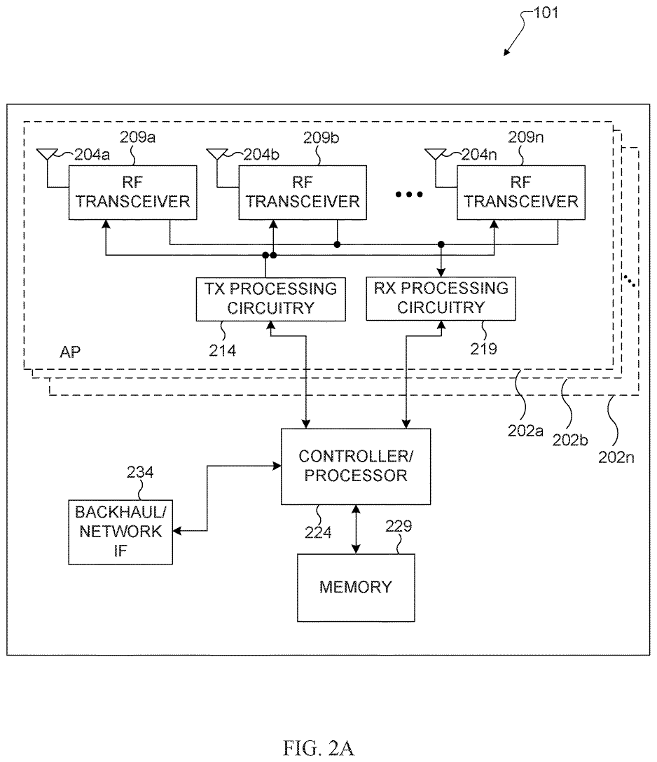

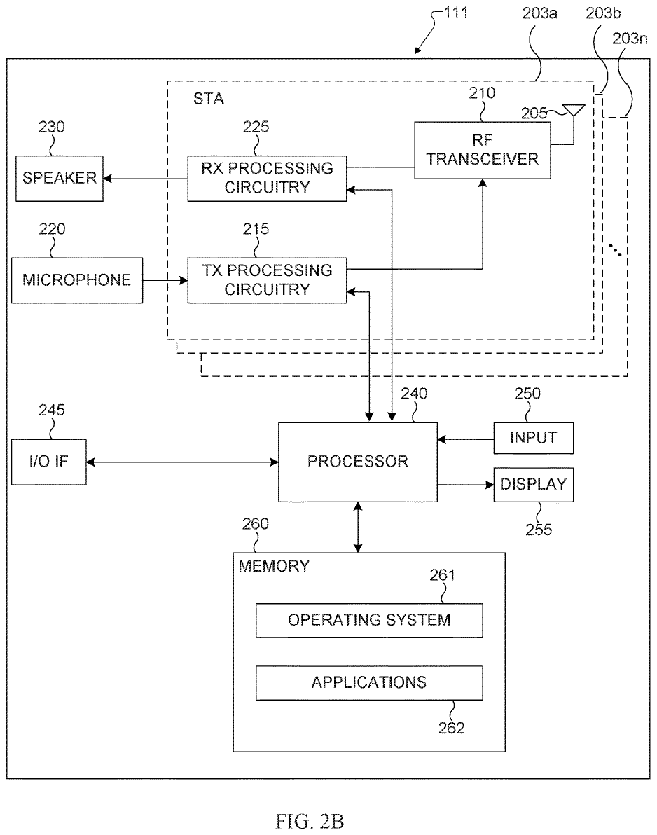

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for supporting a multiple target AP MLD preparation procedure for seamless roaming. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHZ, 5 GHZ, or 6 GHZ, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to support multiple target AP MLD preparation procedure for seamless roaming. In some embodiments, the processor 240 includes at least one microprocessor or microcontroller.

The processor 240 is also capable of executing other processes and programs resident in the memory 260, such as operations for supporting a multiple target AP MLD preparation procedure for seamless roaming. The processor 240 can move data into or out of the memory 260 as required by an executing process. In some embodiments, the processor 240 is configured to execute a plurality of applications 262, such as applications for supporting a multiple target AP MLD preparation procedure for seamless roaming. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that as described in [3], the goal of seamless roaming is to provide mechanisms for a non-AP MLD to transition from a current AP MLD to a target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the important stages are a preparation stage and a roam execution/transition stage. During the preparation stage, the non-AP MLD can setup links with the target AP MLD and perform context transfer. Following this stage, the non-AP MLD can perform a roam execution/transition procedure by sending a request frame to transition from the current AP MLD to the target AP MLD. The current AP MLD can process the request frame and send a response frame to the non-AP MLD after the transfer of context is complete.

These procedures can enable the non-AP MLD to seamlessly roam from the current AP MLD to the target AP MLD.

Embodiments of the present disclosure recognize that when a non-AP MLD that has one or more non-AP STAs affiliated with it, the non-AP MLD is capable of associating with an AP MLD with one or more affiliated AP STAs and setup one or more links with the AP MLD. The AP MLD can be a part of a seamless mobility domain (SMD). The SMD can include multiple AP MLDs where the non-AP MLD can perform an SMD BSS transition procedure between the AP MLDs while maintaining association with the seamless mobility domain management entity (SMD-ME). The SMD BSS transition can be a mechanism for a non-AP MLD to transition from its current AP MLD to a target AP MLD without requiring reassociation. Thus, the SMD BSS transition procedure can minimize the time during which the connectivity between the non-AP MLD and the distribution system (DS) is lost. The non-AP MLD can remain in state 4 of association with the SMD-ME during the SMD BSS transition while preserving the context for data transmission. This can result in a seamless experience. The SMD-ME can provide SMD-level authentication and association, IEEE 802.1X authenticator functions and the Robust Security Network Association (RSNA) key management function for non-AP MLDs across all AP MLDs within the SMD. The SMD can have two data path models between the non-AP MLD and the DS. One data path model can be one where a single MAC SAP is used for the SMD. Another data path model can be one which has a separate MAC SAP per AP MLD of the SMD. At a time, only one of the two data paths can be used.

The non-AP MLD can perform an initial association with the SMD-ME through an AP MLD within the SMD. This association can establish an SMD-level security association across all AP MLDs in the SMD. The non-AP MLD can transition between AP MLDs within this SMD while maintaining its association and security association with the SMD-ME.

The non-AP MLD can use mechanisms such as active scanning (e.g., probing, multi-link probe request and response exchanges, etc.), the BSS transition management (BTM) framework, the neighbor report framework for discovery of the neighboring AP MLDs and the SMD BSS transition support by those AP MLDs.

Further, an AP MLD can use the BTM framework to recommend one or more candidate target AP MLDs within the SMD. The current AP MLD can transmit an unsolicited BTM request containing the candidate target AP's information. The non-AP MLD can also request for information on one or more candidate target AP MLDs in the SMD. The non-AP MLD can transmit a BTM query frame to the current AP MLD and request for candidate target AP MLD's information. Thus, the non-AP MLD can discover the capabilities, feature support and constraints at the target AP MLD.

When the non-AP MLD uses SMD BSS transition to transition from an AP MLD (referred to as the current AP MLD without loss of generality) to another AP MLD within the same SMD (referred to as the target AP MLD), the non-AP MLD can perform an SMD BSS transition preparation procedure. The preparation procedure can be performed in advance before the transition occurs. The preparation procedure can be performed by transmitting a preparation request frame to the current AP MLD. Each preparation request can identify a target AP MLD that the non-AP MLD intends to prepare for a transition. Based on the preparation request, there can be a transfer of context related to the non-AP MLD from the current AP MLD to the target AP MLD. Context can be resources or parameters associated with one or more features setup at the target AP MLD. Examples of contexts can be block acknowledgement (BA) setup parameters, SCS, MSCS, EPCS, etc. that are setup at the current AP MLD. Further, the preparation can also allow the non-AP MLD to add one or more links (i.e., form links with APs) with the target AP MLD. The current AP MLD can transmit a preparation response frame that can inform the non-AP MLD about the status of the preparation, the links added and the contexts out of the requested contexts that have been successfully transmitted. Some contexts can be assumed to be transferred even if not explicitly requested by the non-AP MLD.

The target AP MLD can be kept prepared for a certain period of time. Within this period of time, the non-AP MLD can be required to perform an execution procedure to the target AP MLD. If performed outside this period of time, the preparation can be considered as expired resulting in the context and added links getting deleted. In this case, the execution can fail. This period can be referred to as a timeout period in this disclosure.

The execution procedure can either be performed via the current AP MLD or via the target AP MLD. When the execution procedure is performed via the current AP MLD, the non-AP MLD can transmit an execution request frame to the current AP MLD. The current AP MLD can transfer any context that is required to be transferred (e.g., sequence number (SN)) and that is not already transferred to the target AP MLD. The current AP MLD can transfer an execution response frame to the non-AP MLD. When the execution procedure is performed via the target AP MLD, the non-AP MLD can transmit the execution request frame to the target AP MLD. The target AP MLD can then perform the transfer of any context that is required to be transferred and that is not already transferred from the current AP MLD to the target AP MLD. The target AP MLD can transmit an execution response frame to the non-AP MLD.

According to current IEEE specifications, the non-AP MLD can prepare only one target AP MLD at a time. Additional rules are needed to define the constraints and behavior on the handling of a number of prepared target AP MLDs.

As the non-AP MLD prepares multiple target AP MLDs, its context can be transferred to the target AP MLD and links at the target AP MLD can be setup for the non-AP MLD. As a result, some resources can be reserved for the non-AP MLD at the target AP MLD. There is no way for the network to know which prepared target AP MLD the non-AP MLD will eventually transition to. As a result, this can result in a lot of network resources getting wasted which can be undesirable. A procedure by which the resource wastage can be minimized is needed.

Accordingly, the present disclosure provides a number of solutions for defining constraints and behavior for prepared AP MLDs. Aspects include: a maximum limit on preparation; a loss of prepared AP MLDs; a maximum frequency of preparation; a rejection message; and example operation.

Regarding a maximum limit on preparation, according to one embodiment, there can be a maximum number of AP MLDs that can be prepared by a non-AP MLD for a seamless roam. For example, a non-AP MLD can only have 5 valid prepared AP MLDs at any point in time. An AP MLD can be considered to be in a prepared state for a non-AP MLD when ST preparation is successful and can be considered to be out of the prepared state after the duration specified in the Timeout Value field has elapsed since the end of the PPDU carrying the ACK to the ST preparation response.

This number can be advertised by APs in an SMD. The advertisement can be made in management frames. For example, beacons, probe responses, (re)association responses, etc. The advertisement can be made via an element. For example, the SMD information element can carry this number in the SMD capabilities field.

If a non-AP MLD attempts to exceed this maximum number of allowed preparations, then its earliest preparation can be considered as invalid.

According to another embodiment if a non-AP MLD attempts to exceed this maximum number of allowed preparations, then the preparation request can be denied.

Thus, a non-AP MLD can initiate the SMD BSS transition preparation procedure to prepare a target AP MLD by transmitting an ST preparation request to its current AP MLD. An AP MLD can indicate the maximum number of target AP MLDs that a non-AP MLD is allowed to have in the prepared state at any given time via the Max Number Of Prepared Target AP MLDs field of the SMD Information element it transmits (as described herein below). If the current AP MLD receives a ST preparation request from a non-AP MLD for which the number of target AP MLDs that are in the prepared state is equal to the value of the Max Number Of Prepared Target AP MLD field, then the current AP MLD can indicate in the ST preparation response that the preparation request has been rejected (as described herein below with regard to a rejection message). For instance, by setting the Status Code field to 154 (REJECTED_ST_PREP) in the ST preparation response.

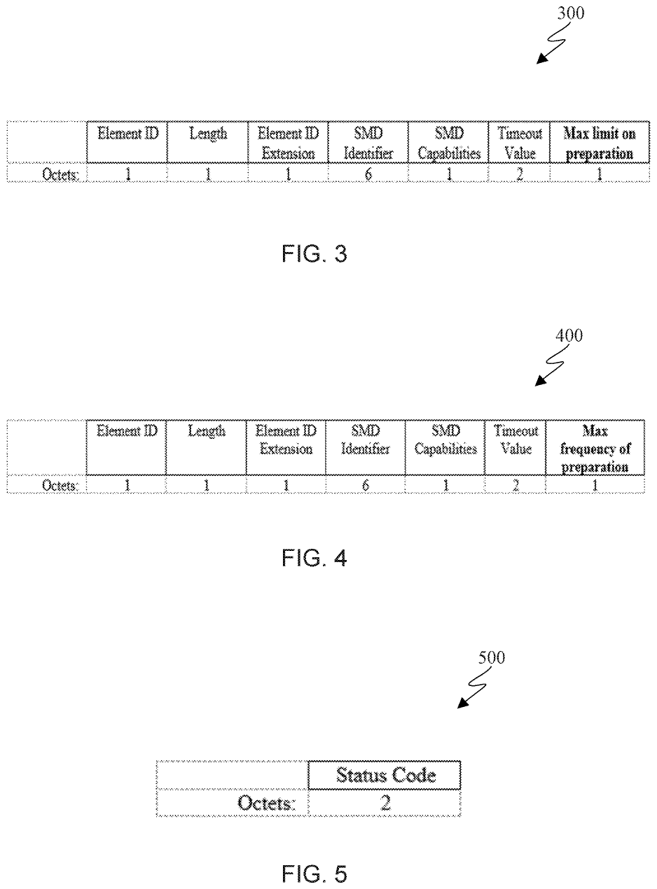

FIG. 3 illustrates an example SMD information element format 300 according to embodiments of the present disclosure. The embodiment of the SMD information element format 300 of FIG. 3 is for illustration only. Different embodiments of the SMD information element format 300 could be used without departing from the scope of this disclosure.

As shown in FIG. 3, according to one embodiment, there can be a field in the SMD Information element related to a maximum limit on preparation. The SMD information element can be carried in management frames. For example, the SMD Information element can be carried in a (Re) association response frame, or a probe response frame.

The maximum limit on preparation field can be set to a number equal to the maximum number of target AP MLDs that can be prepared (with valid preparations) by a non-AP MLD. Alternatively, the field can be set to a value that indicates the maximum number minus 1.

The field ‘Max limit on preparation’ can also be referred to as Max Number Of Prepared Target AP MLDs and can be present in the SMD Capabilities field. It can have a size of 3 octets. Thus, the Max Number Of Prepared Target AP MLDs field can indicate the maximum number of prepared target AP MLDs that a non-AP MLD can be allowed to have in the prepared state at any given time.

Regarding loss of prepared AP MLDs, according to one embodiment, preparing another target AP MLD can result in an invalidation of a previously prepared target AP MLD. This invalidation can occur even before the timeout for preparation has passed.

Regarding a maximum frequency of preparation, according to one embodiment, there can be a maximum frequency of preparation. For example, a non-AP MLD can be allowed to prepare a certain number of AP MLDs over a given/fixed time interval.

FIG. 4 illustrates another example SMD information element format 400 according to embodiments of the present disclosure. The embodiment of the SMD information element format 400 of FIG. 4 is for illustration only. Different embodiments of the SMD information element format 400 could be used without departing from the scope of this disclosure.

As shown in FIG. 4, according to one embodiment, there can be a field in the SMD Information element related to a maximum frequency of preparation. The SMD information element can be carried in management frames. For example, the SMD Information element can be carried in a (Re) association response frame or a probe response frame.

The maximum frequency of preparation field can be set to a number equal to the maximum frequency of preparation.

With regard to a rejection message, according to one embodiment, when a non-AP MLD violates one or more of the preparation constraints/limits listed above (e.g., maximum limit on preparation, maximum frequency of preparation), the non-AP MLD can be provided a rejection message to convey the violation of the constraint.

According to one embodiment, the rejection message can contain at least one or more of the information items as indicated in Table 1.

TABLE 1
Information items that can be present in a rejection message

| Information item | Description |
|---|---|
| Rejection | One or more information item(s) that can indicate a rejection. E.g., |
| indication | status code that can indicate the status is reject due to the violation |
| | such as REJECTED_ST_PREP_MAX_PREP EXCEEDED, a field |
| | (e.g., a bit) that can take a predetermined value (e.g., 1) to make the |
| | indication and to another predetermined value (e.g., 0) to indicate |
| | otherwise. |
| Reference | One or more information item(s) that can indicate the request to |
| indication | which the response corresponds to. E.g., a dialog token. |

When the non-AP MLD receives the rejection message, the non-AP MLD can understand that it cannot perform any preparation to prepare additional AP MLDs for roaming.

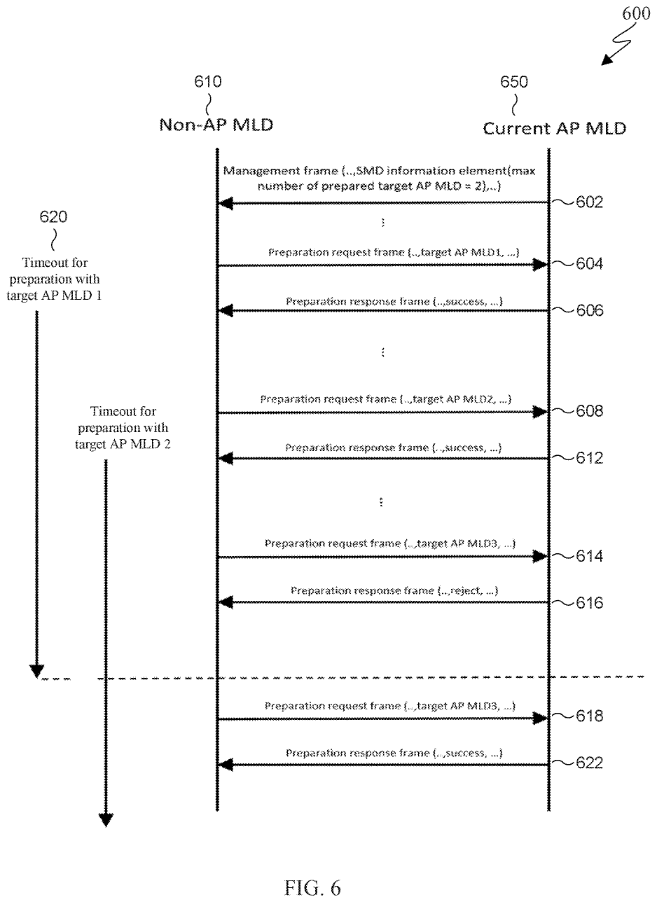

FIG. 5 illustrates an example status code field 500 according to embodiments of the present disclosure. The embodiment of the status code field 500 of FIG. 5 is for illustration only. Different embodiments of the status code field 500 could be used without departing from the scope of this disclosure.

The status code can be present in the seamless transition preparation or execution response frames. Further according to this embodiment, the status code field can be present in the ST Info field carried in the SMD BSS transition parameters element in the UHR link reconfiguration response frame that acts as a ST execution response or ST preparation response.

The status code can take a value as shown in Table 2.

TABLE 2
Status code value

| Name | Meaning |
|---|---|
| REJECTED_PREP | ST preparation request rejected due one or more of the following |
| | reasons: |
| | Maximum limit on preparation exceeded as the non-AP MLD |
| | is attempting to prepare more than max limit on the number |
| | of target AP MLDs that can have valid preparations. |
| | Maximum frequency of preparation is exceeded. |

If there is no reason to reject the preparation request, the status code can be set to SUCCESS.

If the preparation is being rejected due to the above constraints being violated, the reason code can be set to REJECTED_PREP (Note: this name is an example and can take any other name).

FIG. 6 illustrates an example flow diagram of multiple target AP MLD preparation 600 according to embodiments of the present disclosure. The embodiment of the flow diagram of multiple target AP MLD preparation 600 of FIG. 6 is for illustration only. Different embodiments of the flow diagram of multiple target AP MLD preparation 600 could be used without departing from the scope of this disclosure.

As shown in FIG. 6, the non-AP MLD 610 can receive an SMD information element from the current AP MLD 650. The SMD information element can be transmitted via management frames 602 as beacons, (re)association response frames, probe response frames, etc. Upon receiving the SMD information element, the non-AP MLD 610 can understand the maximum number of target AP MLDs that the non-AP MLD can be allowed to maintain a valid preparation with in the SMD. In this example, the maximum number is equal to 2.

When the non-AP MLD 610 transmits an ST preparation request frame 604 to the current AP MLD 650, the current AP MLD 650 can process the ST preparation request and perform necessary communication with the target AP MLD 1 to prepare the target AP MLD 1. The current AP MLD 650 can transmit an ST preparation response frame 606 to the non-AP MLD 610 to indicate a successful preparation. In the same way, target AP MLD2 can be prepared, such that when the non-AP MLD 610 transmits a second ST preparation request frame 608 to the current AP MLD 650, the current AP MLD 650 can process the ST preparation request and perform necessary communication with the target AP MLD 2 to prepare the target AP MLD 2. The current AP MLD 650 can transmit a second ST preparation response frame 612 to the non-AP MLD 610 to indicate a successful preparation.

When the preparations of target AP MLD1 and target AP MLD2 are valid, if the non-AP MLD 610 transmits another ST preparation request frame to the current AP MLD 650, the current AP MLD 650 can reject that request since the maximum number of target AP MLDs that the non-AP MLD is allowed to maintain in this example is 2. To illustrate, if the non-AP MLD 610 transmits a third preparation request frame 614 to the current AP MLD 650 when the preparations of target AP MLD1 and target AP MLD2 are valid that would cause a number of target AP MLDs in the prepared state for the non-AP MLD to exceed the maximum number of target AP MLDs that the non-AP MLD is allowed to maintain (2 in this case), then the current AP MLD 650 can reject that request via preparation response frame 616.

Further, as described herein, the target AP MLD can be kept prepared for a certain period of time (e.g., timeout for preparation with target AP MLD 1) (620). Within this period of time, the non-AP MLD 610 can be required to perform an execution procedure to the target AP MLD 1. If performed outside this period of time, the preparation can be considered as expired resulting in the context and added links getting deleted for target AP MLD 1. In this case, the execution can fail, and the non-AP MLD 610 can transmit another ST preparation request frame 618 (e.g., to prepare the target AP MLD 3) to the current AP MLD 650, which can be accepted by the current AP MLD 650 via preparation response frame 622 since the maximum number of target AP MLDs that the non-AP MLD is allowed to maintain in this example now has not been exceeded.

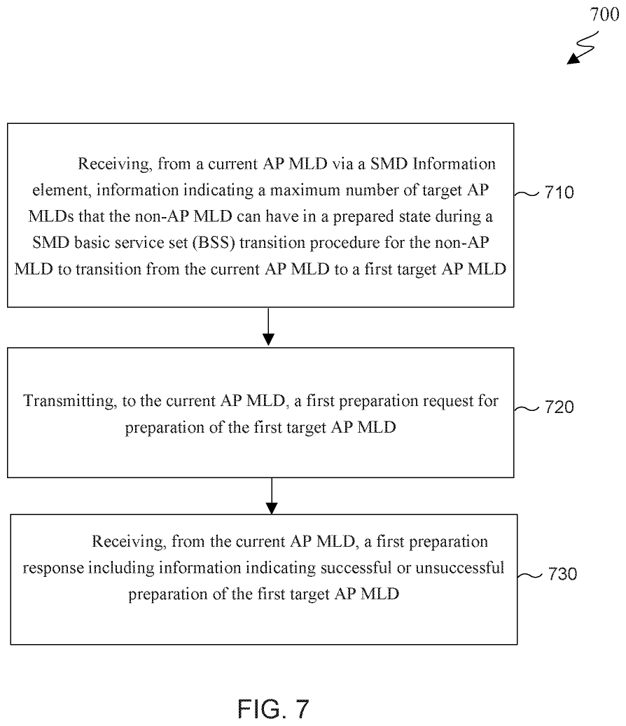

FIG. 7 illustrates an example method 700 performed by a non-access point (AP) multi-link device (MLD) in a wireless communication system according to embodiments of the present disclosure. The method 700 of FIG. 7 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 700 is for illustration only and other embodiments can be used without departing from the scope of the present disclosure.

As illustrated in FIG. 7, the method 700 begins at step 710, where the non-AP MLD receives, from a current AP MLD via a SMD Information element, information indicating a maximum number of target AP MLDs that the non-AP MLD can have in a prepared state during a SMD BSS transition procedure for the non-AP MLD to transition from the current AP MLD to a first target AP MLD. At step 720, the non-AP MLD transmits, to the current AP MLD, a first preparation request for preparation of the first target AP MLD. At step 730, the non-AP MLD receives, from the current AP MLD, a first preparation response including information indicating successful or unsuccessful preparation of the first target AP MLD.

In some embodiments, the SMD Information element is carried in a management frame.

In some embodiments, the SMD Information element includes a Max Number Of Prepared Target AP MLDs field that indicates the maximum number of target AP MLDs that the non-AP MLD can have in the prepared state during the SMD BSS transition procedure.

In some embodiments, the Max Number Of Prepared Target AP MLDs field is included in a SMD Capabilities field of the SMD Information element.

In some embodiments, the non-AP MLD determines the maximum number of target AP MLDs that the non-AP MLD can have in the prepared state during the SMD BSS transition procedure based on a value in the Max Number Of Prepared Target AP MLDs field.

In some embodiments, the non-AP MLD transmits, to the current AP MLD, a second preparation request that would cause a number of target AP MLDs in the prepared state for the non-AP MLD to exceed the value in the Max Number Of Prepared Target AP MLDs field, and receives, from the current AP MLD via a second response, information indicating that the second preparation request is rejected.

In some embodiments, he information indicating that the second preparation request is rejected includes a status code field set to REJECTED_ST_PREP_MAX_PREP_EXCEEDED.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a non-access point (AP) multi-link device (MLD), the method comprising:
receiving, from a current AP MLD via a seamless mobility domain (SMD) Information element, information indicating a maximum number of target AP MLDs that the non-AP MLD can have in a prepared state during a SMD basic service set (BSS) transition procedure for the non-AP MLD to transition from the current AP MLD to a first target AP MLD;
transmitting, to the current AP MLD, a first preparation request for preparation of the first target AP MLD; and
receiving, from the current AP MLD, a first preparation response including information indicating successful or unsuccessful preparation of the first target AP MLD.

2. The method of claim 1, wherein the SMD Information element is carried in a management frame.

3. The method of claim 1, wherein the SMD Information element includes a Max Number Of Prepared Target AP MLDs field that indicates the maximum number of target AP MLDs that the non-AP MLD can have in the prepared state during the SMD BSS transition procedure.

4. The method of claim 3, wherein the Max Number Of Prepared Target AP MLDs field is included in a SMD Capabilities field of the SMD Information element.

5. The method of claim 3, further comprising determining the maximum number of target AP MLDs that the non-AP MLD can have in the prepared state during the SMD BSS transition procedure based on a value in the Max Number Of Prepared Target AP MLDs field.

6. The method of claim 3, further comprising:
transmitting, to the current AP MLD, a second preparation request that would cause a number of target AP MLDs in the prepared state for the non-AP MLD to exceed the value in the Max Number Of Prepared Target AP MLDs field; and
receiving, from the current AP MLD via a second response, information indicating that the second preparation request is rejected.

7. The method of claim 6, wherein the information indicating that the second preparation request is rejected includes a status code field set to REJECTED_ST_PREP_MAX_PREP_EXCEEDED.

8. A method performed by a current access point (AP) multi-link device (MLD), the method comprising:
transmitting, to a non-AP MLD via a seamless mobility domain (SMD) Information element, information indicating a maximum number of target AP MLDs that the non-AP MLD can have in a prepared state during a SMD basic service set (BSS) transition procedure for the non-AP MLD to transition from the current AP MLD to a first target AP MLD;
receiving, from the non-AP MLD, a first preparation request for preparation of the first target AP MLD; and
transmitting, to the non-AP MLD, a first preparation response including information indicating successful or unsuccessful preparation of the first target AP MLD.

9. The method of claim 8, wherein the SMD Information element is carried in a management frame.

10. The method of claim 8, wherein the SMD Information element includes a Max Number Of Prepared Target AP MLDs field that indicates the maximum number of target AP MLDs that the non-AP MLD can have in the prepared state during the SMD BSS transition procedure.

11. The method of claim 10, wherein the Max Number Of Prepared Target AP MLDs field is included in a SMD Capabilities field of the SMD Information element.

12. The method of claim 10, further comprising:
receiving, from the non-AP MLD, a second preparation request that would cause a number of target AP MLDs in the prepared state for the non-AP MLD to exceed the value in the Max Number Of Prepared Target AP MLDs field; and
transmitting, to the non-AP MLD via a second response, information indicating that the second preparation request is rejected.

13. The method of claim 12, wherein the information indicating that the second preparation request is rejected includes a status code field set to REJECTED_ST_PREP_MAX_PREP_EXCEEDED.

14. A non-access point (AP) multi-link device (MLD) comprising:
at least one processor including processing circuitry; and
memory storing instructions, wherein the instructions, when executed by the at least one processor individually or collectively, cause the non-AP MLD to:
receive, from a current AP MLD via a seamless mobility domain (SMD) Information element, information indicating a maximum number of target AP MLDs that the non-AP MLD can have in a prepared state during a SMD basic service set (BSS) transition procedure for the non-AP MLD to transition from the current AP MLD to a first target AP MLD;
transmit, to the current AP MLD, a first preparation request for preparation of the first target AP MLD; and
receive, from the current AP MLD, a first preparation response including information indicating successful or unsuccessful preparation of the first target AP MLD.

15. The non-AP MLD of claim 14, wherein the SMD Information element is carried in a management frame.

16. The non-AP MLD of claim 14, wherein the SMD Information element includes a Max Number Of Prepared Target AP MLDs field that indicates the maximum number of target AP MLDs that the non-AP MLD can have in the prepared state during the SMD BSS transition procedure.

17. The non-AP MLD of claim 16, wherein the Max Number Of Prepared Target AP MLDs field is included in a SMD Capabilities field of the SMD Information element.

18. The non-AP MLD of claim 16, wherein the instructions, when executed by the at least one processor individually or collectively, cause the non-AP MLD to determine the maximum number of target AP MLDs that the non-AP MLD can have in the prepared state during the SMD BSS transition procedure based on a value in the Max Number Of Prepared Target AP MLDs field.

19. The non-AP MLD of claim 16, wherein the instructions, when executed by the at least one processor individually or collectively, cause the non-AP MLD to:
transmit, to the current AP MLD, a second preparation request that would cause a number of target AP MLDs in the prepared state for the non-AP MLD to exceed the value in the Max Number Of Prepared Target AP MLDs field; and
receive, from the current AP MLD via a second response, information indicating that the second preparation request is rejected.

20. The non-AP MLD of claim 19, wherein the information indicating that the second preparation request is rejected includes a status code field set to REJECTED_ST_PREP_MAX_PREP_EXCEEDED.
